(19) United States
(12) Patent Application Publication
(10) Pub. No.: US 2013/0114779 A1
(43) Pub. Date: May 9, 2013

(54) APPARATUS FOR CHARGING EMERGENCY BATTERY USING THERMOELECTRIC GENERATION DEVICE IN NUCLEAR POWER PLANT

(71) Applicants: Sang Jong LEE, Daejeon (KR); Seoung Eun CHUN, Daejeon (KR); Geol Woo LEE, Daejeon (KR); Byeong Tae YU, Daejeon (KR); Joon Sung KIM, Daejeon (KR); Tae Young YOON, Daejeon (KR); Sung Min CHOI, Daejeon (KR); Hye Jin KIM, Daejeon (KR); Sang Jung PARK, Daejeon (KR); Hyoung Gun SHIM, Daejeon (KR)

(72) Inventors: Sang Jong LEE, Daejeon (KR); Seoung Eun CHUN, Daejeon (KR); Geol Woo LEE, Daejeon (KR); Byeong Tae YU, Daejeon (KR); Joon Sung KIM, Daejeon (KR); Tae Young YOON, Daejeon (KR); Sung Min CHOI, Daejeon (KR); Hye Jin KIM, Daejeon (KR); Sang Jung PARK, Daejeon (KR); Hyoung Gun SHIM, Daejeon (KR)

(73) Assignee: KEPCO NUCLEAR FUEL CO., LTD., Daejeon (KR)

(21) Appl. No.: 13/603,185

(22) Filed: Sep. 4, 2012

(30) Foreign Application Priority Data
Sep. 8, 2011 (KR) 10-2011-0091157

(51) Int. Cl. G21C 9/02

(52) U.S. Cl. CPC G21C 9/02
USPC 376/282

(57) ABSTRACT

An apparatus for charging an emergency battery, which provides an emergency power to an emergency core cooling apparatus including an electric pump or a steam pump includes a thermoelectric generation device configured to detect a decay heat and a residual heat produced in a nuclear power plant and configured to convert the detected heat to an electric energy; an electric energy conversion unit connected to the thermoelectric generation device to output a current generated in the thermoelectric generation device as a constant voltage; and the emergency battery configured to store a power outputted from the electric energy conversion unit.

### CROSS-REFERENCE TO RELATED APPLICATIONS

The present application claims priority benefits under 35 U.S.C. §119 to Korean Patent Application No. 10-2011-0091157, filed Sep. 08, 2011.

### BACKGROUND OF THE INVENTION

1. Field of the Invention

The present invention relates to an apparatus for charging an emergency battery to supply an emergency power to an emergency core cooling apparatus of a nuclear power plant, and more particularly to an apparatus for charging an emergency battery by using a decay heat and a residual heat generated in a nuclear plant by installing a thermoelectric generation device on a nuclear power generation system such as, for example, a nuclear reactor, a hot leg pipe, a cold leg pipe, and a steam generator, which has a temperature difference therein.

2. Description of the Related Art

In a nuclear power plant using a pressurized water reactor, an unexpected safety accident can occur even if a design of the nuclear power plant has an adequate margin of safety. In case of an accident where a massive amount of a cooling water is caused to leak or a power supply is interrupted, a sufficient amount of an emergency cooling water may not be provided such that a reactor core is overheated to damage a nuclear reactor.

Therefore, in order to cool the reactor core in the event of an accident, an emergency core cooling apparatus needs to be functionally operable. A current emergency core cooling apparatus provides a cooling water by using an electric pump or a steam driven auxiliary feed water pump.

In order to enable an effective operation of the emergency core cooling apparatus, a power supply to the electric pump or the steam pump is necessary. Generally, the power supply is provided by using an offsite power supply, an emergency diesel generator, or a battery.

In case of the accident where the massive amount of the cooling water is caused to leak or the power supply is interrupted, if an emergency diesel generator, etc., breaks down, a power supply to the emergency core cooling apparatus and accident handling equipment cannot operate due to a power outage.

Although an emergency battery can be used to supply power to the emergency core cooling apparatus, thereby providing a cooling water to the reactor core, a typical emergency battery currently used in a domestic nuclear power plant has only about an 8 hour battery life. Therefore, when a longer period of time is elapsed to handle the accident, the power supply to the emergency core cooling apparatus will be interrupted.

To solve the problem of cooling a reactor core in the event of an accident, many prior art systems have been suggested including a system having a direct injection nozzle by which an emergency core coolant bypass flow is minimized, disclosed in Korean Patent No. 10-0568762, and an emergency core cooling method and an apparatus therefor using a reactor vessel and a compressed tank, disclosed in Korean Patent No. 10-0419194. However, there has been no disclosure of techniques for charging the emergency battery by using a heat produced in the nuclear reactor through a thermoelectric generation device, thereby effectively supplying a power to the emergency core cooling apparatus when an accident occurs in which a power supply to the emergency core cooling apparatus is interrupted.

### SUMMARY OF THE INVENTION

Accordingly, the present invention has been made keeping in mind the above mentioned problems occurring in the related art, and an object of the present invention is to provide an apparatus for charging an emergency battery using a heat generated in a nuclear reactor, when the emergency battery is used to supply power to maintain a cooling operation of an emergency core cooling apparatus in case an accident occurs in a nuclear power plant in which a power supply is interrupted and an emergency diesel generator has a mechanical breakdown such that a power supply to the emergency core cooling apparatus is not effective.

Meanwhile, a power generated using the heat produced in the nuclear reactor may be generated by using a thermoelectric generation device, wherein the thermoelectric generation device may be installed on a plurality of locations within the nuclear power plant where a temperature difference exists.

In order to accomplish the above mentioned object, the present invention provides an apparatus for charging an emergency battery, which provides an emergency power to an emergency core cooling apparatus including an electric pump or a steam pump, the apparatus comprising: a thermoelectric generation device configured to detect a decay heat and a residual heat produced in a nuclear power plant and configured to convert the detected heat to an electric energy; an electric energy conversion unit connected to the thermoelectric generation device to output a current generated in the thermoelectric generation device as a constant voltage; and the emergency battery configured to store a power outputted from the electric energy conversion unit.

The thermoelectric generation device may be installed on at least one of a cold leg pipe, a nuclear reactor vessel, a hot leg pipe, and a steam generator.

The thermoelectric generation device may include a heat transfer fin formed on both ends thereof.

The thermoelectric generation device may include a cooling fin formed on one end thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration view illustrating an apparatus for charging an emergency battery in which a thermoelectric generation device is mounted on a cold leg pipe, a nuclear reactor, and a hot leg pipe according to the present invention;

FIG. 1(a) is a cross-sectional view taken along line A-A′ in FIG. 1.

FIG. 2 is a configuration view illustrating a thermoelectric generation device according to the present invention; and

FIG. 3 is a configuration view illustrating a thermoelectric generation device including a cooling fm according to the present invention.

### DETAILED DESCRIPTION OF THE INVENTION

Exemplary embodiments of the present invention will be described herein below with reference to the accompanying drawings. Throughout the drawings, like reference numbers are used to identify like elements. Also, in the following description, well-known functions or constructions are not described in detail since they would obscure the invention in unnecessary detail.

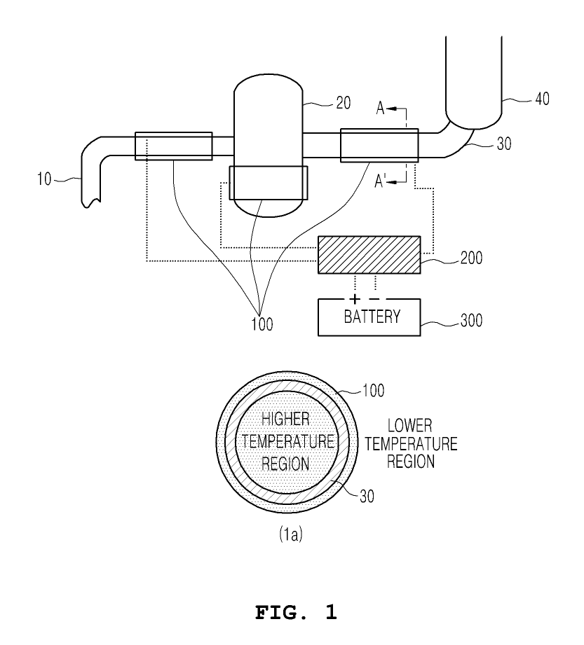

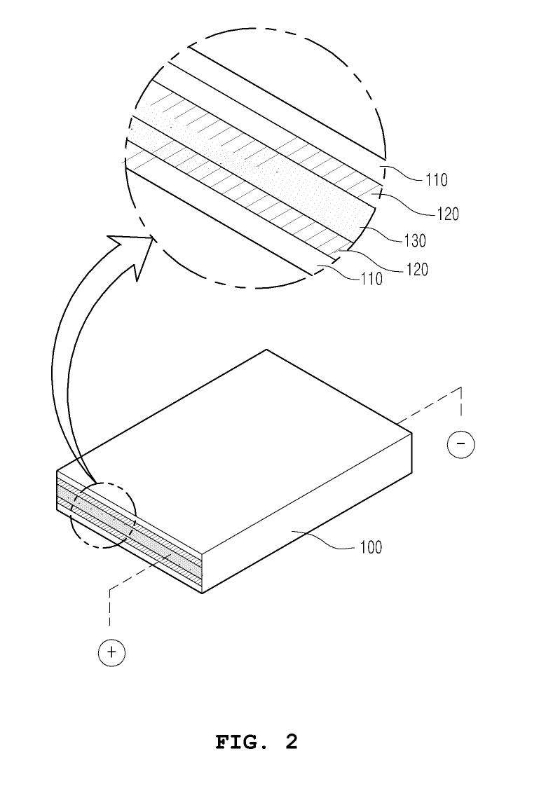

As shown in FIGS. 1 through 3, an apparatus for charging an emergency battery in a nuclear power plant using an a thermoelectric generation device according to the present invention (hereinafter, “present invention”) includes a thermoelectric generation device 100 for converting, upon detection of a decay heat and a residual heat generated in the nuclear power plant, the detected heat into an electric energy, an electric energy conversion unit 200 for outputting a current generated in the thermoelectric generation device 100 as a constant voltage, and an emergency battery 300 for storing a power outputted from the electric energy conversion unit 200.

As shown in FIG. 1 in detail, in a current nuclear power plant, an emergency core cooling apparatus performs a core cooling operation when an accident occurs. In this case, a required power is provided from an offsite power source, and when the offsite power is not available, an emergency diesel generator is used to produce electricity. Meanwhile, when all power supply is interrupted, a power is provided by using the emergency battery 300.

The thermoelectric power generation device 100 produces electricity in a simple manner by using a phenomenon, which is called Seebeck's principle, in which a current is caused to flow due to a difference in electromotive force created by a temperature difference between two ends of a metal. Thus, by using the temperature difference between the two ends of the metal, a heat generated in the nuclear reactor can be used to create the electromotive force without requiring a mechanical drive part, compared to other power generation systems. Accordingly, it is possible to generate electricity by using the heat generated in the nuclear reactor. Also, the electromotive force can be continuously generated until the nuclear reactor is cooled down, even when a temperature is not constant and the nuclear reactor stops operating and thus fails to output a normal output

The electric energy conversion unit 200 converts the current generated in the thermoelectric generation device 100 into a constant voltage to be outputted, thereby charging the emergency battery 300.

Even when an accident occurs in which a power of the nuclear power plant is interrupted, a power is provided to an electric pump or a steam pump provided in the emergency core cooling apparatus by using, for example, the emergency diesel generator or the emergency battery 300 in order to maintain an operation of the emergency core cooling apparatus. Therefore, by supplying a cooling water to a reactor core by using the emergency diesel generator and the emergency battery 300, a reactor core meltdown or damage to the nuclear reactor due to an overheated reactor core can be delayed or prevented. However, when a mechanical breakdown occurs in the emergency diesel power generator, the power is supplied by the emergency battery 300 to the emergency core cooling apparatus and other peripheral devices for handling the accident. However, the emergency battery 300 has a limited capacity such that, if a longer time is elapsed to handle the accident, an effective power supply to the emergency core cooling apparatus is interrupted, thereby affecting a cooling operation thereof. In such a case, due to overheating of the reactor core, a serious accident such as the reactor core meltdown may occur.

Whether the nuclear reactor operates normally or stops operating, the decay heat and the residual heat is remained in a cold leg pipe 10, a nuclear reactor 20, a hot leg pipe 30, or a steam generator 40. Accordingly, at least one thermoelectric generation device 100 is mounted on the cold leg pipe 10, the nuclear reactor 20, the hot leg pipe 30, and the steam generator 40 to produce power using the decay heat and the residual heat remaining in the nuclear reactor, and the power produced by the thermoelectric power generation device 100 is converted, by the electric energy conversion unit 200, into a voltage having a certain level to be outputted. The power output from the electrical energy conversion unit 200 is stored in the emergency battery 300, thereby charging the emergency battery 300. Therefore, when the power supply is stopped and the emergency diesel engine has a mechanical breakdown such that power is not effectively supplied to the electric pump or the steam pump equipped in the emergency core cooling apparatus, the power can be supplied to the emergency core cooling system by using the emergency battery 300. Thus, even when handling accident requires a long period of time and an accident site is not accessible by a person so that no separate power supply is not available, the power can be supplied to the electric pump or the steam driven pump by using the emergency battery 300, which is stably operated through the emergency battery charging apparatus of the nuclear power plant using the thermoelectric generation device. Accordingly, the emergency core cooling apparatus can continue to perform a normal cooling operation.

On the other hand, when the nuclear core inside the nuclear reactor is cooled down so that the power cannot be produced by using the thermoelectric power generation device 100 any longer, the emergency core cooling apparatus does not need to operate. In this case, if a nuclear response of the nuclear core is increased and a high temperature is created due to an increase in the decay heat and the residual heat, the thermoelectric generation device 100 can generate a power having a certain level or higher to be provided to the emergency battery 300. Accordingly, the emergency battery 300 can effectively provide the power to the electric pump or the steam pump to perform the cooling operation of the emergency core cooling apparatus.

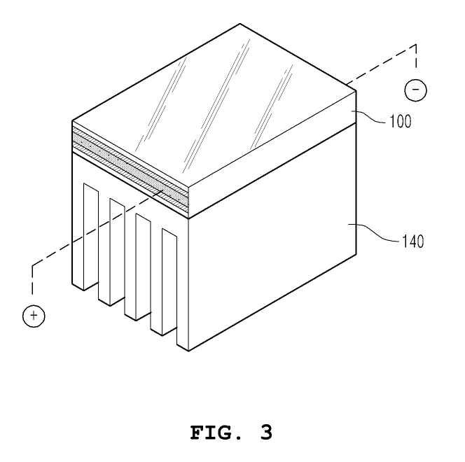

In addition, as shown in FIG. 3, in order to ensure sufficiently low temperature for efficient power generation by the thermoelectric generation device 100, a cooling fin 140 can be installed on a lower portion of the thermoelectric generation device 100. Also, in order to increase heat transfer rate of the decay heat and the residual heat produced in the nuclear power plant, a heat transfer plate can be further included in the thermoelectric generation device 100.

According to the present invention, an apparatus for charging the emergency battery using the thermoelectric generation device is provided, wherein the emergency battery is used to provide the emergency power to the emergency core cooling apparatus equipped with the electric pump or the steam pump. Accordingly, when a power supply to the emergency core cooling apparatus is not effective because, for example, the power supply is interrupted and the emergency diesel generator has a mechanical breakdown, the emergency battery for supplying the power to the emergency core cooling apparatus can be charged with the decay heat and the residual heat, which is produced in the nuclear reactor and serves as a higher temperature region of the thermoelectric generation device, thereby supplying the power to the emergency core cooling apparatus or a device that preferentially needs to be used for emergency cooling operation. Therefore, damage to the nuclear reactor due to the overheating of the nuclear core can be delayed or prevented.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for charging an emergency battery, which provides an emergency power to an emergency core cooling apparatus including an electric pump or a steam pump, the apparatus comprising:
a thermoelectric generation device configured to detect a decay heat and a residual heat produced in a nuclear power plant and configured to convert the detected heat to an electric energy;
an electric energy conversion unit connected to the thermoelectric generation device to output a current generated in the thermoelectric generation device as a constant voltage; and
the emergency battery configured to store a power outputted from the electric energy conversion unit.

2. The apparatus according to claim 1, wherein the thermoelectric generation device is installed on at least one of a cold leg pipe, a nuclear reactor vessel, a hot leg pipe, and a steam generator.

3. The apparatus according to claim 1, wherein the thermoelectric generation device includes a heat transfer fin formed on both ends thereof.

4. The apparatus according to claim 1, wherein the thermoelectric generation device includes a cooling fin formed on one end thereof.

5. The apparatus according to claim 2, wherein the thermoelectric generation device includes a heat transfer fin formed on both ends thereof.

6. The apparatus according to claim 2, wherein the thermoelectric generation device includes a cooling fin formed on one end thereof.
